(19) United States
(12) Patent Application Publication
(10) Pub. No.: US 2013/0270919 A1
(43) Pub. Date: Oct. 17, 2013

(54) ABOVE RESONANCE FREQUENCY OPERATION FOR WIRELESS POWER TRANSFER

(71) Applicant: John M. Miller, Oak Ridge, TN (US)

(72) Inventor: John M. Miller, Oak Ridge, TN (US)

(73) Assignee: UT-BATTELLE, LLC, Oak Ridge, TN (US)

(21) Appl. No.: 13/447,447

(22) Filed: Apr. 16, 2012

(51) Int. Cl. H01F 38/00

(52) U.S. Cl. 307/104

(57) ABSTRACT

A wireless power transmission system includes a primary circuit and a secondary circuit, which are coupled through coupling coils. The primary circuit includes an alternating current (AC) power supply source that provides an alternating current signal through a series connection of a primary capacitor and a primary coil. The secondary circuit includes a parallel connection of a secondary coil, a secondary capacitor, and a load. The resonance frequency f₀ of the wireless power transmission system is a frequency at which the power transfer efficiency of the wireless transmission system achieves a maximum for an infinitesimally small resistive load. The operational frequency of the AC power supply source is selected to be above the resonance frequency f₀ so as to provide greater efficiency and/or greater power transfer rate in the presence of a finite impedance load.

### STATEMENT REGARDING FEDERALLY SPONSORED RESEARCH OR DEVELOPMENT

This invention was made with United States government support under Prime Contract No. DE-AC05-00OR22725 awarded by the U.S. Department of Energy. The United States government has certain rights in this invention.

### FIELD OF THE INVENTION

The present invention relates to the field of inductive power transmission, and particularly to an apparatus and a method for wirelessly transmitting power through coupling coils that are spaced from each other at an off-resonance operational frequency to achieve higher transfer efficiency than the transfer efficiency at the resonance frequency.

### BACKGROUND OF THE INVENTION

Wireless power transfer employing coupling coils is discussed, for example, in A. Kurs, A. Karalis, R. Moffatt, J. D. Jonnopolos, P. Fisher, and M. Soljaic, “Wireless Power Transfer via Strong Coupled Magnetic Resonance,” Science, vol. 317, pp. 83-86, 2007. The coupling coils that can be employed for wireless power transfer include a primary coil and a secondary coil that are separated by an air gap. The width of the air gap, i.e., the separation distance between the primary coil and the secondary coil, can be, for example, from a few inches to a few feet within the coupling coils provided that the secondary coil is configured to capture some magnetic flux generated by the primary coil.

In a wireless power transfer system, it is desirable to design the coupling coils such that the power transfer characteristics and efficiency of the wireless power transfer system do not critically depend on the alignment between the primary coil and the secondary coil or the distance therebetween. In other words, it is desirable that a first structural part including a primary coil can be physically displaced from a second structural part including a secondary coil, and can be subsequently put together without requiring a precise alignment therebetween in order to enable efficient power transfer.

The potential to displace and reposition the secondary coil relative to the primary coil in a system of inductively coupled coils can be exploited to enable inductive power transfer from a power outlet to an electrical vehicle. Methods of transferring power through inductive coupling are shown, for example, in U.S. Pat. Nos. 6,934,167 to Jang et al., 6,934,165 to Adler et al., and 6,418,038 to Takahama et al and in U.S. Patent Application Publication Nos. 2009/0322307 to Ide and 2009/0303753 to Fu et al.

Prior art methods transfer power at a resonance frequency f₀ of an air core transformer, which is given by:

$${f}_{0} = \frac{1}{2 π \sqrt{LC}} ,$$

in which L is the inductance of the circuit including the primary coil and C is the capacitance of the circuit including the primary coil. The resistance of the circuit including the primary coil is not considered in determining the resonance frequency f₀, although the resistance of the circuit including the primary coil affects the Q-factor of the resonance. The circuit parameters of the secondary circuit including the secondary coil are selected to induce resonance at the resonance frequency f₀, i.e., such that the product of the inductance and the capacitance of the secondary circuit matches the product of the inductance and the capacitance of the primary circuit.

### SUMMARY OF THE INVENTION

A wireless power transmission system including coupling coils can be operated at an operating frequency greater than the resonance frequency of the wireless power transmission system in order to provide a greater power transfer efficiency and/or a greater power transfer rate compared to operation of the same wireless power transmission system at the resonance frequency.

A wireless power transmission system includes a primary circuit and a secondary circuit, which are coupled through coupling coils. The primary circuit includes an alternating current (AC) power supply source that provides an alternating current signal through a series connection of a primary capacitor and a primary coil. The secondary circuit includes a parallel connection of a secondary coil, a secondary capacitor, and a load. The primary coil and the secondary coil collectively constitute the coupling coils. The resonance frequency f₀ of the wireless power transmission system is a frequency at which the power transfer efficiency of the wireless transmission system achieves a maximum for an infinitesimally small resistive load on the secondary circuit. By selecting an operational frequency greater than the resonance frequency f₀, the wireless power transfer system including a finite impedance load can provide greater efficiency and/or greater power transfer rate than during operation at the resonance frequency. The operational frequency of the AC power supply source can be selected so that the wireless power transfer efficiency of the system is at a maximum for the finite impedance load.

In one embodiment, the primary capacitor can have a first capacitance C₁, and the primary coil can have a first self-inductance L₁. The secondary coil can have a second self-inductance L₂, and the secondary capacitor can have a second capacitance C₂. The primary coil and the secondary coil collectively constitute the coupling coils. The inductances and capacitances of the primary coil, the secondary coil, the primary capacitor, and the secondary capacitor are selected such that the product of the first inductance L₁ and the first capacitance C₁ is substantially the same as the product of the second inductance L₂ and the second capacitance C₂. The primary circuit and the secondary circuit have a same resonance frequency f₀ given by

$${f}_{0} = \frac{1}{2 π \sqrt{LC}} ,$$

in which LC=L₁C₁=L₂C₂.

The operational frequency of the AC power supply source is selected to be above the resonance frequency f₀, thereby providing a higher power transfer efficiency than operation of the AC power supply source at the resonance frequency f₀. The amount of shift in the operational frequency f₀ from the resonance frequency f₀ can be determined by the impedance of the load and the operational frequency f₀. The shift in the operational frequency f₀ from the resonance frequency f₀ can be, for example, from 0.01% to 100% of the magnitude of the resonance frequency f₀.

According to an aspect of the present disclosure, an apparatus for wireless power transmission is provided. The apparatus includes: an inductive coupling structure including a primary coil and a secondary coil, wherein at least one of the primary coil and the secondary coil is movable, the primary coil being a component of a primary circuit including a primary capacitor in a connection with the primary coil, and the secondary coil being a component of a secondary circuit including a secondary capacitor in connection with the secondary coil; an alternating current (AC) power supply source present within the primary circuit; and a finite impedance load present within the secondary circuit and connected to the secondary coil and the secondary capacitor, wherein the AC power supply source is configured to provide an input power to the primary coil and the primary capacitor at an operational frequency f that is greater than a resonance frequency f₀ at which the inductive coupling structure provide a maximum power transfer efficiency between the primary circuit and the secondary circuit for a hypothetical circuit in which the finite impedance load is substituted with an infinitesimally small resistive load.

According to another aspect of the present disclosure, a method of operating an apparatus for wireless power transmission is provided. The method includes: providing an apparatus for wireless power transmission that includes: an inductive coupling structure including a primary coil and a secondary coil, wherein at least one of the primary coil and the secondary coil is movable, the primary coil being a component of a primary circuit including a primary capacitor in a connection with the primary coil, and the secondary coil being a component of a secondary circuit including a secondary capacitor in connection with the secondary coil; and an alternating current (AC) power supply source present within the primary circuit. The method further comprises connecting a finite impedance load to the secondary circuit, wherein the finite impedance load is connected to the secondary coil and the secondary capacitor; and providing an input power to the primary coil and the primary capacitor, employing the AC power supply source, at an operational frequency f that is greater than a resonance frequency f₀ at which the inductive coupling structure provide a maximum power transfer efficiency between the primary circuit and the secondary circuit for a hypothetical circuit in which the finite impedance load is substituted with an infinitesimally small resistive load.

### BRIEF DESCRIPTION OF THE DRAWINGS

FIG. 1 is a schematic of a circuit of a first exemplary wireless power transfer apparatus according to an embodiment of the present disclosure.

FIG. 2 is a schematic of a circuit for an alternating current (AC) power supply source including an H-bridge circuit according to an embodiment of the present disclosure.

FIG. 3A is a vertical cross-sectional view of an exemplary inductive coupling structure according to an embodiment of the present disclosure.

FIG. 3B is a horizontal cross-sectional view of the exemplary inductive coupling structure along the plane X1-X1′ in FIG. 3A.

FIG. 3C is a horizontal cross-sectional view of the exemplary inductive coupling structure along the plane X2-X2′ in FIG. 3A.

FIG. 4 is a schematic for an exemplary rectifier according to an embodiment of the present disclosure.

FIG. 5 includes two graphs illustrating results of a simulation for the frequency dependency of the primary active power and the primary reactive power of the first exemplary wireless power transfer apparatus according to an embodiment of the present disclosure.

FIG. 6 is a graph of measured direct current (DC) to DC efficiency of an experimental hardware embodying the first exemplary wireless power transfer apparatus.

FIG. 7A is a schematic of a circuit of a second exemplary wireless power transfer apparatus at a first circuit parameter setting according to an embodiment of the present disclosure.

FIG. 7B is a graph of simulated circuit characteristics for the circuit of FIG. 7A illustrating the magnitude of the primary current and the magnitude of the secondary current as a function of the operating frequency.

FIG. 8A is a schematic of a circuit of the second exemplary wireless power transfer apparatus at a second circuit parameter setting according to an embodiment of the present disclosure.

FIG. 8B is a graph of simulated circuit characteristics for the circuit of FIG. 8A illustrating the magnitude of the primary current, the magnitude of the secondary current, and the magnitude of the secondary voltage as a function of the operating frequency.

FIG. 9A is a schematic of a circuit of the second exemplary wireless power transfer apparatus at a third circuit parameter setting according to an embodiment of the present disclosure.

FIG. 9B is a graph of simulated circuit characteristics for the circuit of FIG. 9A illustrating the magnitude of the primary current, the magnitude of the secondary current, and the magnitude of the secondary voltage as a function of the operating frequency.

FIG. 10A is a schematic of a circuit of the second exemplary wireless power transfer apparatus at a fourth circuit parameter setting according to an embodiment of the present disclosure.

FIG. 10B is a graph of simulated circuit characteristics for the circuit of FIG. 10A illustrating the magnitude of the primary current and the magnitude of the secondary current as a function of the operating frequency.

FIG. 11A is a schematic of a circuit of the second exemplary wireless power transfer apparatus at a fifth circuit parameter setting according to an embodiment of the present disclosure.

FIG. 11B is a graph of simulated circuit characteristics for the circuit of FIG. 11A illustrating the magnitude of the primary current, the magnitude of the secondary current, and the magnitude of the secondary voltage as a function of the operating frequency.

FIG. 12A is a schematic of a circuit of the second exemplary wireless power transfer apparatus at a sixth circuit parameter setting according to an embodiment of the present disclosure.

FIG. 12B is a graph of simulated circuit characteristics for the circuit of FIG. 12A illustrating the magnitude of the primary current, the magnitude of the secondary current, and the magnitude of the secondary voltage as a function of the operating frequency.

FIG. 13 is a graph for wireless power transfer power output for an ideal coil in a configuration having k=0.23.

FIG. 14 is a top-down view of an exemplary first structure that can be employed an inductive coupling structure according to an embodiment of the present disclosure.

FIG. 15 is a bar graph of power factor during an experiment designed to demonstrate the concept of the shifting of the peak in operational frequency for maximum power transfer.

### DETAILED DESCRIPTION OF THE INVENTION

As stated above, the present invention relates to an apparatus and a method for wirelessly transmitting power through coupling coils that are spaced from each other at an off-resonance operational frequency to achieve higher transfer efficiency than the transfer efficiency at resonance frequency, which are now described in detail with accompanying figures. It is noted that like and corresponding elements mentioned herein and illustrated in the drawings are referred to by like reference numerals.

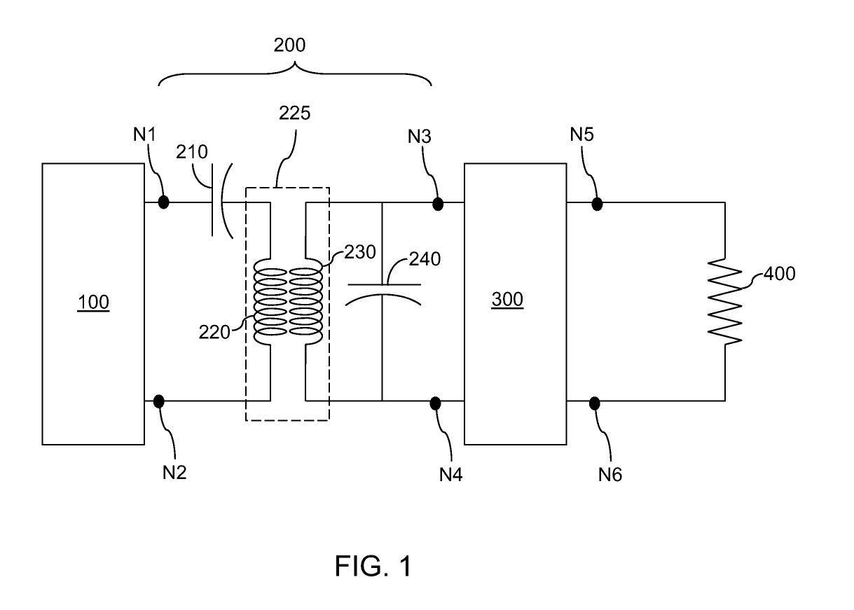

Referring to FIG. 1, a first exemplary wireless power transfer apparatus according to an embodiment of the present disclosure includes an alternating current (AC) power supply source 100, a resonance circuit 200 including an inductive coupling structure 225, and a finite impedance load that includes a rectifier 300 and a resistive load 400. The transfer coils 225 include a primary coil 220 and a secondary coil 230. The primary coil 220 and the secondary coil 230 are movable relative to each other. The coupling coefficient k of the transfer coils 225 is defined by Φ2/Φ1, in which Φ1 is the magnetic flux that is generated by, and passes through, the primary coil 220, and Φ2 is the magnetic flux that is generated by the primary coil 220 and passes through the secondary coil 230.

The primary coil 220 is a component of a primary circuit. The primary circuit includes the AC power supply source 100, the primary coil 220, and a primary capacitor 210 in a connection with the primary coil 220. In one embodiment, the primary coil 220 and the primary capacitor 210 are in a series connection. In one embodiment, an output node of the AC power supply source 100 is connected directly to an end of the series connection, and another output node of the AC power supply source 100 is connected directly to another end of the series connection. For example, a first node N1, which is an output node of the AC power supply source 100, can be connected directly to a node of the primary capacitor 210 located at one end of the series connection, and a second node N2, which is another output node of the AC power supply source 100, can be connected directly to a node of the primary coil 220 located at another end of the series connection.

The secondary coil 230 is a component of a secondary circuit. The secondary circuit includes the secondary coil 230, a secondary capacitor 240 in connection with the secondary coil 230, the rectifier 300, and the resistive load 400. In one embodiment, the secondary coil 230 and the secondary capacitor 240 are in a parallel connection.

In one embodiment, one end of the finite impedance load (300, 400) is connected directly to an end of said parallel connection of the secondary coil 230 and the secondary capacitor 240, and another end of the finite impedance load (300, 400) is connected directly to another end of the parallel connection of the secondary coil 230 and the secondary capacitor 240.

In one embodiment, the secondary coil 230 and the secondary capacitor 240 are connected to input nodes of the rectifier 300, and the resistive load 400 is connected to output nodes of the rectifier 300. For example, a third node N3, which is an input node of the rectifier 300, can be connected directly to a node of a common end of the parallel connection of the secondary coil 230 and the secondary capacitor 240, and a fourth node N4, which is another input node of the rectifier 300, can be connected directly to a node of another common end of the parallel connection of the secondary coil 230 and the secondary capacitor 240. One end of the resistive load 400 can be connected directly to an output node of the rectifier 300, i.e., a fifth node N5, and another end of the resistive load 400 can be connected directly to another output node of the rectifier 300, i.e., a sixth node N6.

In one embodiment, the rectifier 300 within the finite impedance load can be omitted. In other words, the finite impedance load can consist of the resistive load 400. The third node N3 can coincide with the fifth node N5, and the fourth node N4 can coincide with the sixth node N6. In this case, one end of the resistive load 400 can be connected directly to an end of the parallel connection of the secondary coil 230 and the secondary capacitor 240, and another end of the resistive load 400 can be connected directly to another end of the parallel connection of the secondary coil 230 and the secondary capacitor 240.

The resistive load 400 can be a resistor, a resistive electrical element, or a back EMF generating device such as a battery that functions as a load that needs charging and applies a back EMF in proportion to the voltage that accumulates therein upon charging. The impedance of the resistive load 400 is essentially real, i.e., does not include imaginary components of any significant magnitude that materially affects the resistive characteristics of the impedance of the resistive load 400. A rectifying capacitor 310, which functions as a filter capacitor, acts as a battery upon charging by imposing an electromotive force (EMF) load at the rectifier terminals.

The resonant circuit 200 has a resonance frequency f₀, which is defined as the frequency at which the inductive coupling structure 225 provide a maximum power transfer efficiency between the primary circuit and the secondary circuit for a hypothetical circuit in which the finite impedance load (300, 400) is substituted with an infinitesimally small resistive load.

In one embodiment, the primary coil 220 can have a first self-inductance L₁ and the primary capacitor 210 can have a first capacitance C₁. A first resonant frequency f₁ can be defined such that

$${f}_{1} = \frac{1}{2 π \sqrt{{L}_{1} {C}_{1}}} .$$

In one embodiment, device components in the second circuit can be selected such that the resonance frequency f₀ of the resonant circuit 200 is the same as the first resonant frequency f₁. In this case, values for the first self-inductance L₁ and the first capacitance C₁ satisfy a relationship given by

$${f}_{0} = \frac{1}{2 π \sqrt{{L}_{1} {C}_{1}}} .$$

In addition, the secondary coil 230 can have a second self-inductance L₂ and the secondary capacitor 240 can have a second capacitance C₂. A second resonant frequency f₂ can be defined such that

$${f}_{2} = \frac{1}{2 π \sqrt{{L}_{2} {C}_{2}}} .$$

In one embodiment, device components in the first circuit can be selected such that the resonance frequency f₀ of the resonant circuit 200 is the same as the second resonant frequency f₂. In this case, values for the second self-inductance L₂ and the second capacitance C₂ satisfy a relationship given by

$${f}_{0} = \frac{1}{2 π \sqrt{{L}_{2} {C}_{2}}} .$$

In one embodiment, the resonance frequency f₀ of the resonant circuit 200 can be the same as the first resonant frequency f₁ and the second resonant frequency f₂.

The components of the resonant circuit 200 can be selected such that the resonance frequency f₀ is from 1 kHz to 1 MHz, although the resonance frequency f₀ can be lower than 1 kHz or greater than 1 MHz in some embodiments. In one embodiment, the resonance frequency f₀ can be within a range from 10 kHz to 150 kHz.

According to a method of the present disclosure, the first exemplary wireless power transfer apparatus can be operated such that an input power is provided to the primary coil 220 and the primary capacitor 210, employing the AC power supply source 100, at an operational frequency f that is greater than the resonance frequency f₀. The operational frequency f can be selected such that a power transfer efficiency and/or a power transfer rate is greater at the operational frequency f than at the resonance frequency f₀. Further, the first exemplary wireless power transfer apparatus can be configured to operate at such an operational frequency f that provides a power transfer efficiency and/or a power transfer rate that is greater than at the resonance frequency f₀. The ratio of the operational frequency f to the resonance frequency f₀ is greater than 1.000. In one embodiment, the ratio of the operational frequency f to the resonance frequency f₀ can be in a range from 1.0001 to 2.0000.

In one embodiment, the primary circuit and the secondary circuit can be located in two separate structures, of which at least one is movable. In one embodiment, a first structure including the primary circuit can be stationary, and a second structure including the secondary circuit can be movable. In another embodiment, a first structure including the primary circuit can be movable, and a second structure including the secondary circuit can be movable. In one embodiment, the second structure can be a vehicle configured to move on a road, in off-road terrain on land, on water, in water, or in air.

In one embodiment, at least one of the primary coil 220 and the secondary coil 230 can be configured to be movable without any limitation on the maximum separation distance between the primary coil 220 and the secondary coil 230. In one embodiment, the entirety of the space between the primary coil and the secondary coil can be an air gap.

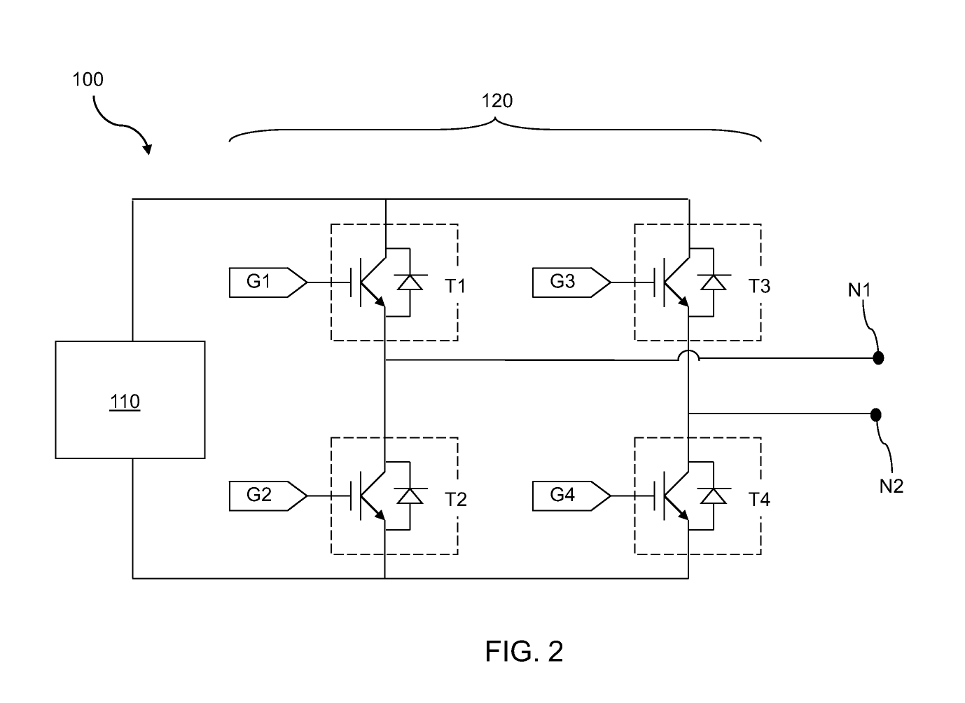

Referring to FIG. 2, an exemplary circuit for implementing the AC power supply source 100 is illustrated. In one embodiment, the AC power supply source 100 can include a direct current (DC) power source 110 and a high frequency power inverter 120. The high frequency power inverter 120 can generate a periodic waveform in a frequency range from 1 kHz to 1 MHz, although frequencies less than 1 kHz or greater than 1 MHz can also be employed.

In one embodiment, the DC power source 110 can be a battery that provides a constant voltage across input nodes of the high frequency power inverter 120. In another embodiment, the DC power source 110 can be configured to generate a constant voltage from an alternating current (AC) power supply that operates at a nominal frequency from 50 Hz to 60 Hz and at a nominal voltage from 110 V to 220V, i.e., the AC voltage available at residential buildings. The constant voltage generated from the AC power supply that operates at a frequency from 50 Hz to 60 Hz is provided to the input nodes of the high frequency power inverter 120.

The high frequency power inverter 120 can employ any circuit that can generate a periodic waveform that mimics a sinusoidal waveform, for example, in a frequency range from 1 kHz to 1 MHz. In one embodiment, the high frequency power inverter 120 can include an H-bridge circuit including of four insulated gate bipolar transistors (IGBT's). The four IGBT's are labeled as T1, T2, T3, and T4, respectively. The four IGBT's switch on and off in alternate legs to convert a DC input voltage supplied from the DC power source into an alternating square wave output that is provided across the first node N1 and the second node N2. The switching of the four IGBT's can be controlled by controlling the voltages applied to the various gates of the four IGBT's, which are labeled G1, G2, G3, and G4, respectively. In some embodiments, the IGBT's can be replaced with power metal oxide semiconductor field effect transistors (MOSFET's) or similar semiconductor devices capable of controlled turn-on and turn-off.

For example, the IGBT's labeled T1 and T4 can turn on simultaneously, while the IGBT's labeled T2 and T3 are turned off during a first portion of a cycle to cause electrical current to flow from the first node N1 into the rest of the primary circuit including the primary capacitor 210 and the primary coil 220 (See FIG. 1) and then into the second node N2. During a second portion of the cycle, the IGBT's labeled T2 and T3 turn on simultaneously, while the IGBT's labeled T1 and T4 are turned off to cause electrical current to flow from the second node N2 into the rest of the primary circuit including the primary coil 220 and the primary capacitor 210 (See FIG. 1) and then into the first node N1. In one embodiment, the duty cycles of the various IGBT's can be optimized so that the output voltage across the first node N1 and the second node N2 resembles sinusoidal wave. For example, the duty cycles of the various IGBT's can be optimized so that the deviation of the output waveform across the first node N1 and the second node N2 deviates least from a sinusoidal wave as calculated by a least root mean square deviation method. The timing of switching of the various IGBT's can be controlled, for example, by a digital signal processor (not shown). Other power sources or converters such as a flyback transformer can also be used instead.

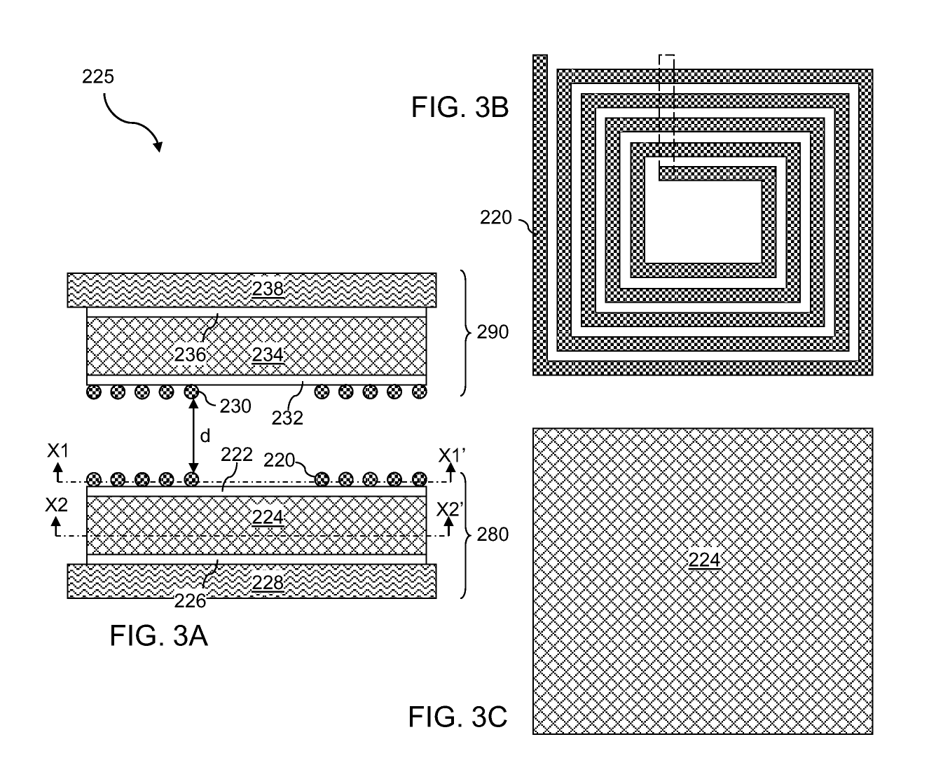

Referring to FIGS. 3A-3C, an exemplary inductive coupling structure 225 is shown. In the exemplary inductive coupling structure 225, at least one of the primary coil 220 and the secondary coil 230 can be moved without any limitation on the maximum separation distance between the primary coil 220 and the secondary coil 230. The entirety of the space between the primary coil and the secondary coil can be an air gap. Each of the primary coil 220 and the secondary coil 230 can be attached to another structure. For example, the primary coil 220 can be a part of a first structure 280, and the secondary coil 230 can be a part of a second structure 290.

The first structure 280 includes the primary coil 220 that is wound within a first two-dimensional plane. An end portion of the primary coil 220 that crosses over the wound portion of the primary coil 220 can be placed such that the end portion is farther away from the secondary coil 230 than the would portion of the primary coil 220. Further, the end portion of the primary coil 220 is routed to avoid electrically shorting with the wound portion of the primary coil 220. The first structure 280 can further include an optional insulator layer 222 located on the back side of the primary coil 220, a first ferromagnetic plate 224 configured to capture and direct the magnetic flux generated from an alternating current that passes through the primary coil 220 in a direction perpendicular to the plane of the windings of the primary coil 220, and a first back side insulator layer 226 that insulates the first ferromagnetic plate 224 from a first metallic plate 228. The first metal plate 228 provides a shielding of the magnetic field generated by the primary coil 220, and minimizes the penetration of the magnetic field through the first metal plate 228. The first metal plate 228 causes any magnetic field produced by the primary coil 220 that is not fully guided up toward the secondary coil 230 to be effectively shielded from extending beyond the first metal plate 228.

The second structure 290 includes the secondary coil 230 that is wound within a second two-dimensional plane. An end portion of the secondary coil 230 that crosses over the wound portion of the secondary coil 230 can be placed such that the end portion is farther away from the primary coil 220 than the would portion of the secondary coil 230. Further, the end portion of the secondary coil 230 is routed to avoid electrically shorting with the wound portion of the secondary coil 230. The second structure 280 can further include an optional insulator layer 232 located on the back side of the secondary coil 230, a second ferromagnetic plate 234 configured to capture and direct the magnetic flux generated from an alternating current that passes through the secondary coil 230 within the windings of the secondary coil 230, and a second back side insulator layer 236 that insulates the second ferromagnetic plate 234 from a second metallic plate 238. The second metal plate 238 provides a shielding of the magnetic field generated by the primary coil 220, and minimizes the penetration of the magnetic field through the second metal plate 238.

The optional insulator layer 222, the first back side insulator layer 226, the optional insulator layer 232, and the second back side insulator layer 236 can include an insulator material such as Kapton® by DuPont™. The first and second ferromagnetic plates (224, 234) can include any ferromagnetic material known in the art including ferrites. Non-limiting examples of such ferrite materials include Ferroxcube 3C94 material by Phillips and low loss MnZn materials manufactured by Spectrum Magnetics, LLC. The first structure 280 and the second structure 290 can be brought together such that the first two-dimensional plane and the second two-dimensional plane are substantially parallel to each other prior to operation of the circuit of FIG. 1 to effect a wireless power transfer operation. The distance between the primary coil 220 and the secondary coil 230 can be selected so that the coupling constant k is a significant non-zero number. In one embodiment, the coupling constant k can be from 0.001 to 0.999. In another embodiment, the coupling constant k can be greater than 0.01. In yet another embodiment, the coupling constant k can be greater than 0.1. In still another embodiment, the coupling constant can be greater than 0.15. In even another embodiment, the coupling constant can be less than 0.5. In still another embodiment, the coupling constant can be less than 0.3. In one embodiment, the distance between the primary coil 220 and the secondary coil 230 can be varied such that the coupling constant k can be continuously varied between a lower limit, e.g., 0.01, to an upper limit, e.g., 0.99.

A physical model for the exemplary inductive coupling structure 225 as constructed at Oak Ridge National Laboratory during a research leading to the present disclosure employed a primary coil 220 and a secondary coil 230, each of which was wound along a periphery of a square surface of a 400 mm×500 mm rectangular ferrite plate employed as the first ferromagnetic plate 224 or as the second ferromagnetic plate 234, respectively. End turns of each of the primary coil 220 and the secondary coil 230 extended beyond the periphery in the 400 mm direction, and was contained within the periphery along the 500 mm direction. Each of the first back side insulator layer 226, the first metallic plate 228, the second back side insulator layer 236, and the second metallic plate 238 had a form of a 660 mm×660 mm square plate to allow mounting holes and a Lexan® cover plate to be attached. The coupling constant k for the physical model varied depending on the spacing s between the primary coil 220 and a secondary coil 230. When the spacing s was 100 mm, the coupling constant k was 0.488. When the spacing s was 125 mm, the coupling constant k was 0.389. When the spacing s was 150 mm, the coupling constant k was 0.312. When the spacing s was 175 mm, the coupling constant k was 0.251. When the spacing s was 200 mm, the coupling constant k was 0.203.

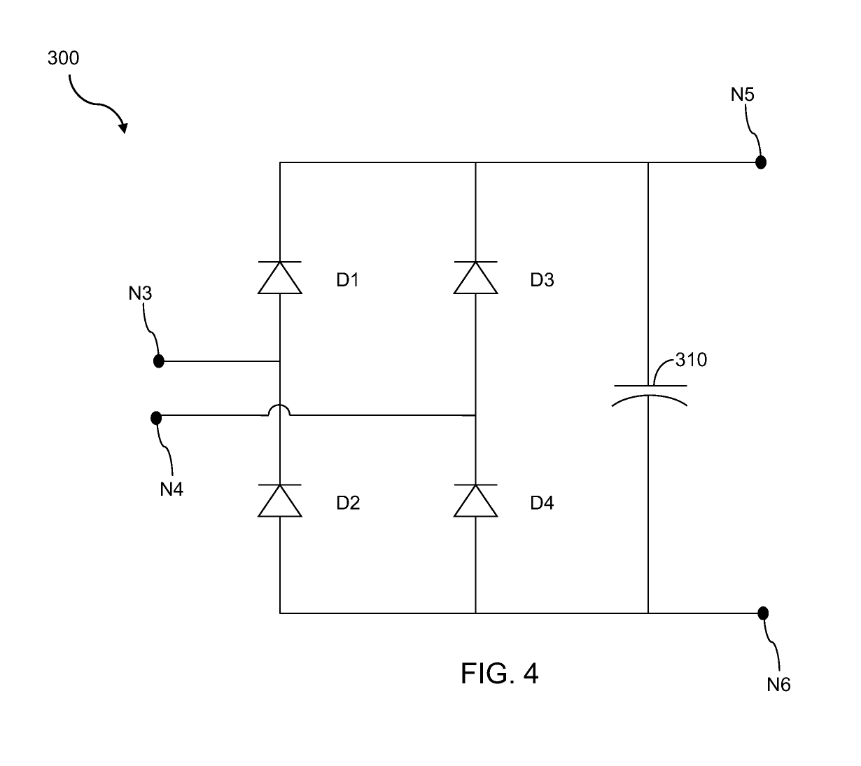

Referring to FIG. 4, an exemplary rectifier 300 is illustrated, which includes four diodes labeled D1, D2, D3, and D4, respectively, and a rectifying capacitor 310. The first diode D1 and the fourth diode D4 form a first pair, and the second diode D2 and the third diode D3 form a second pair. The four diodes are arranged such that electrical current can flow through one of the two pairs of diodes irrespective of the phase of the electrical current and to cause a rectified electrical current to flow in a predefined direction, i.e., from the fifth node N5 to the sixth node N6. The capacitance of the rectifying capacitor 310 is selected such that the voltage across the fifth node N5 and the sixth node N6 remain substantially constant.

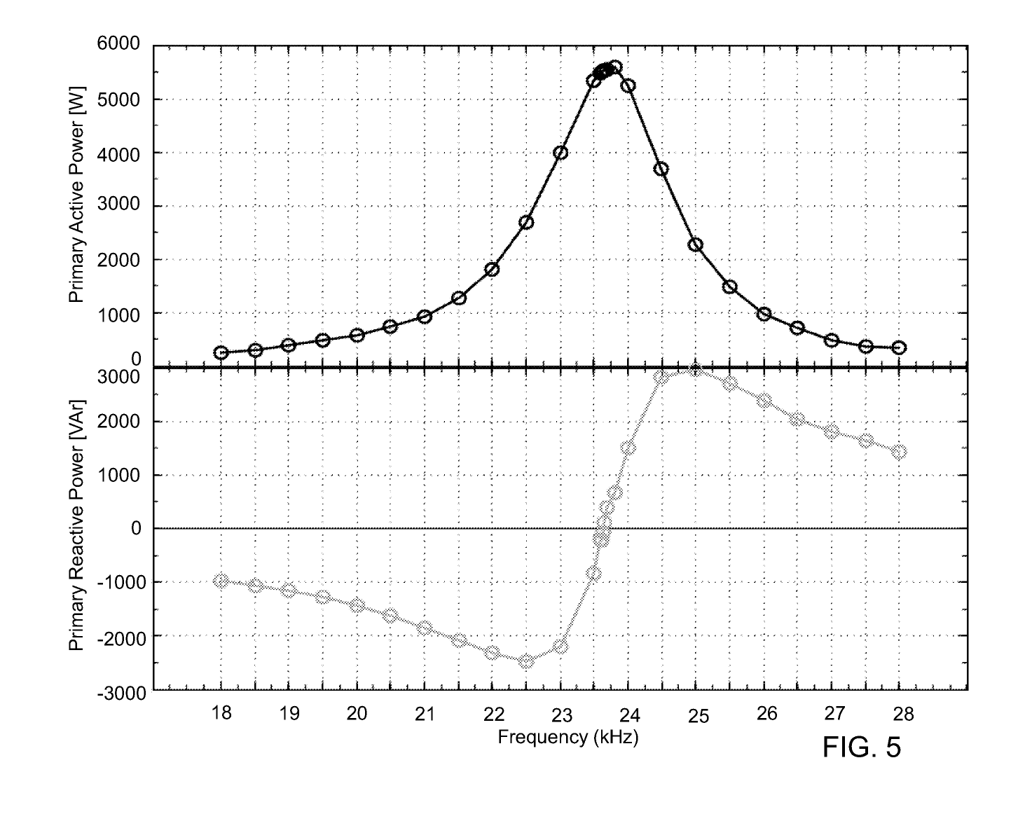

Referring to FIG. 5, two graphs illustrate results of a simulation for the frequency dependency of primary active power and the primary reactive power of the first exemplary wireless power transfer apparatus at a setting in which the various parameters of the first exemplary wireless power transfer apparatus are as listed in Table 1. The simulation was performed employing a computer model in MathLab Simulink® that is representative of the experimental hardware and control algorithm as implemented at Oak Ridge National Laboratory during a research leading to the present disclosure.

TABLE 1
A setting for various parameters of the first exemplary
wireless power transfer apparatus of FIG. 1

| | | |
|---|---|---|
| DC voltage of the DC power source 110 | 70 | V |
| Duty cycle of the high frequency power inverter 120 | 0.81 | |
| First capacitance C₁ of the primary capacitor 210 | 1.447 | μF |
| First Self-inductance L₁ of the primary coil 220 | 36.1 | μH |
| First intrinsic AC resistance R₁ of the primary coil 220 | 34.6 | mΩ |
| Second capacitance C₂ of the secondary capacitor 240 | 1.447 | μF |
| Second self-inductance L₂ of the secondary coil 230 | 36.1 | μH |
| Second intrinsic AC resistance R₂ of the secondary coil 220 | 34.6 | mΩ |
| Coupling constant k of the inductive coupling structure 225 | 0.300 | |
| Capacitance of the rectifying capacitor 310 | 1.000 | mF |
| Resistance of the resistive load 400 | 9.2 | Ω |

It is noted that the first intrinsic AC resistance R₁ of the primary coil 220 is the sum of the DC value of the resistance of the conductors of the primary circuit including the primary coil 220 and the AC skin and proximity resistance due to high frequency current flow Likewise, and the second intrinsic AC resistance R₂ of the secondary coil 230 is the sum of the DC value of the resistance of the conductors of the secondary circuit including the secondary coil 220 and the AC skin and proximity resistance due to high frequency current flow. For example, the DC resistance of the primary circuit was measured to be 18.7 mΩ, but at 25 kHz the total resistance of the primary circuit was measured to be 36.1 mΩ due to AC effects. The primary active power P_{1A} is given by

$${P}_{1 A} = [ \frac{{\int }_{0}^{T} {V}_{1} ( t ) {A}_{1} ( t ) d t}{T} ] ,$$

i.e., the real part of the integral of the product of the primary voltage V₁(t) as measured across the first node N1 and N2 and the primary current A₁(t) that flows through the primary coil 220 over the period T of the primary voltage V₁(t) divided by the period of the primary voltage V₁(t). The primary reactive power P_{1R} is given by

$${P}_{1 R} = Im [ \frac{{\int }_{0}^{T} {V}_{1} ( t ) {A}_{1} ( t ) d t}{T} ] ,$$

i.e., the imaginary part of the integral of the product of the primary voltage V₁(t) as measured across the first node N1 and N2 and the primary current A₁(t) that flows through the primary coil 220 over the period T of the primary voltage V₁(t) divided by the period of the primary voltage V₁(t).

The resonance frequency f₀ is given by the following equation:

$${f}_{0} = {f}_{1} = \frac{1}{2 π \sqrt{{L}_{1} {C}_{1}}} = {f}_{2} = \frac{1}{2 π \sqrt{{L}_{2} {C}_{2 }}} .$$

The value of the resonance frequency f₀ is about 22.07 kHz in this case.

The primary voltage V₁(t), the primary current A₁(t), the secondary voltage V₂(t) as measured across the third node N3 and the fourth node N4, and the secondary current A₂(t) that flows through the secondary coil 230 are substantially sinusoidal because the impedance of the resonance circuit 200 is much greater at harmonic frequencies of the operational frequency f of the high frequency power inverter 120, i.e., the operation frequency f of the AC power supply source 100.

The graph of the primary active power P_{1A} in FIG. 5 illustrates that the peak in the primary active power P_{1A} occurs at a frequency of about 23.70 kHz, while the resonance frequency f₀ is about 22.07 kHz. Thus, the peak in the primary active power P_{1A} occurs at a frequency greater than the resonance frequency f₀ of about 22.07 kHz. Further, the point at which the primary reactive power P_{1R} becomes zero occurs at a frequency of about 23.65 kHz, which is greater than the resonance frequency f₀ of about 22.07 kHz. It is noted that the primary current A₁(t) leads the primary voltage V₁(t) at frequencies less than 23.65 kHz, and the primary current A₁(t) lags the primary voltage V₁(t) at frequencies greater than 23.65 kHz.

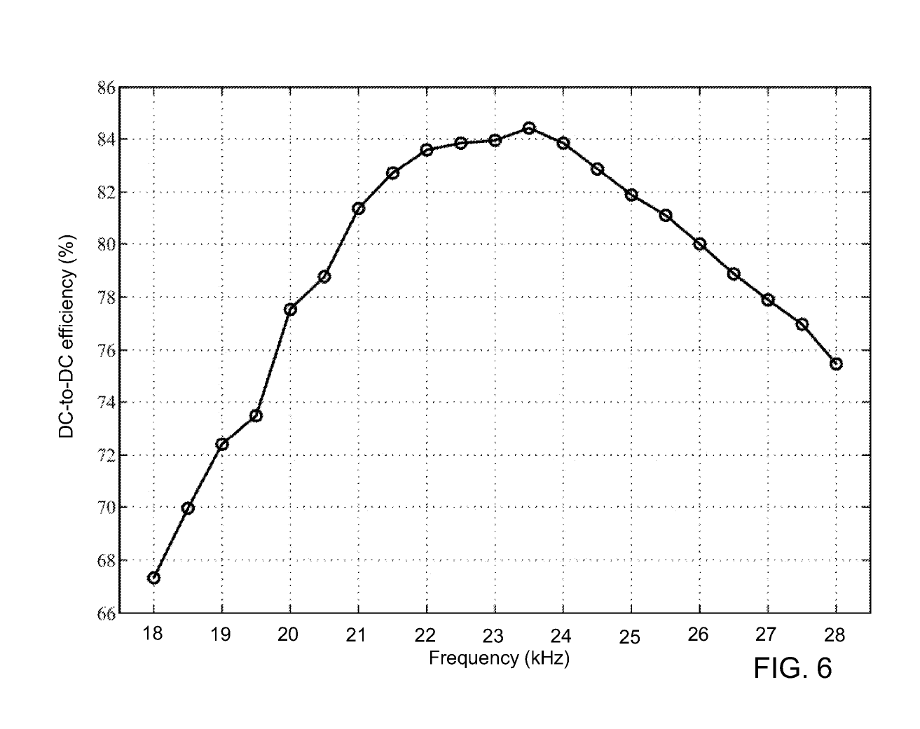

Referring to FIG. 6, a graph illustrates the measured direct current to direct current (DC-to-DC) efficiency of an experimental hardware embodying the first exemplary wireless power transfer apparatus of FIG. 1 as constructed at Oak Ridge National Laboratory. The DC voltage of the DC power source 110 was set at 55 V. The coupling constant k was set at 0.312 (corresponding to a spacing s of 150 mm in the physical model for the exemplary inductive coupling structure 225 as constructed at Oak Ridge National Laboratory). Some of the values for the first capacitance C₁ of the primary capacitor 210, the first self-inductance L₁ of the primary coil 220, the second capacitance C₂ of the secondary capacitor 240, and the second self-inductance L₂ of the secondary coil 230 deviated from the corresponding values listed in Table 1 such that the first resonance frequency f₁ and the second frequency f₂ were set at 22.4 kHz.

The DC-to-DC efficiency is the ratio of the power generated at the resistive load 400 relative to the total power provided by the DC power source 110. The peak in the DC-to-DC efficiency occurs at about 23.5 kHz, and has a value of about 84.4%. The loss of 15.6% of the input power as provided by the DC power source 110 is partly attributed to a loss within the AC power supply source 100, and is partly attributed to a loss at the rectifier 300. Specifically, the IGBT's within the high frequency power inverter 120 cause a total voltage drop of about 3.60V, which is twice a voltage drop across a single IGBT because the current path at any instant includes two IGBT's in a series connection (i.e., the combination of T1 and T4 or the combination of T2 and T3; See FIG. 2). Thus, the efficiency ηᵢₙᵥ of the high frequency power inverter 120 is given by:

$${η}_{inv} ≅ \frac{1}{( 1 + \frac{2 {U}_{SW \_ ON}}{{U}_{d}} + {f}_{sw} )} = \frac{1}{( 1 + \frac{3.6 V}{55 V} + 0.045 )} = 0.90 .$$

U_{SW}_{_{—}}_{ON} is the voltage drop across a single IGBT (or an equivalent power switching device) at the high frequency power inverter 120, U_{d} is the DC power supply voltage at the inverter input, and f_{sw} is a degradation factor due to switching at the operating frequency of the high frequency power inverter 120.

Further, the rectifier 300 causes voltage drop due to the finite voltages across diodes during rectification. Thus, the efficiency η_{rec} of the rectifier 300 is given by:

$${η}_{rec} ≅ \frac{1}{( 1 + \frac{2 {U}_{FD}}{{U}_{do}} + {f}_{sw}^{d} )} = \frac{1}{( 1 + \frac{2.2 V}{120 V} + 0.012 )} = 0.97 .$$

U_{FD} is the forward bias voltage across a single diode within the rectifier 300, U_{do} is the DC voltage at the output node of the rectifier 300, and f_{sw}^{d} is a degradation factor due to switching at the operating frequency of the rectifier 300.

The coupling coil efficiency η_{coil} of the inductive coupling structure 225 as constructed at Oak Ridge National Laboratory is given by:

$${η}_{coil} ≅ \frac{{P}_{0}}{( {P}_{0} + {I}_{1}^{2} {R}_{1} + {I}_{2}^{2} {R}_{2 } )} = \frac{1 \text{,} 800 W}{( 1 \text{,} 800 + 104 W + 6 W )} = 0.94 .$$

P₀ is the power transferred to the resistive load on the secondary circuit, I₁ is the root mean square magnitude of the primary current, R₁ is the first intrinsic AC resistance, I₂ is the root mean square magnitude of the secondary current, and R₂ is the second intrinsic AC resistance.

The DC-to-DC efficiency η_{dc-dc} is given by:

η_{dc-dc}=ηᵢₙᵥη_{coil}η_{rec}=0.90×0.94×0.97≅0.82.

At another load point, a coupling coil efficiency η_{coil} of 94% was achieved for the inductive coupling structure 225. In this case, the estimated DC-to-DC efficiency η_{dc-dc} is about 84%.

Simulations show that the operational frequency f of the AC power supply source 100 needs to be increased with the increase of the resistance of the resistive load 400 in order to maintain maximum power transfer efficiency. The maximum efficiency frequency at which the efficiency of the power transfer (i.e., the ratio of the output power delivered to the resistive load 400 to the input power provided across the first node N1 and the second N2) is maximized is also a function of the coupling constant k. Thus, determination of the maximum efficiency frequency typically requires a circuit simulation or an experimental testing.

Further, simulations show that transient responses within the first exemplary wireless power transfer apparatus dissipates within 10 ms. Specifically, the experimental hardware constructed at the Oak Ridge National Laboratory was evaluated in simulation for high power burst mode operation by commanding the power inverter to be enabled for 23 ms. This test showed that the transient response dissipated within 10 milliseconds for all measured parameters.

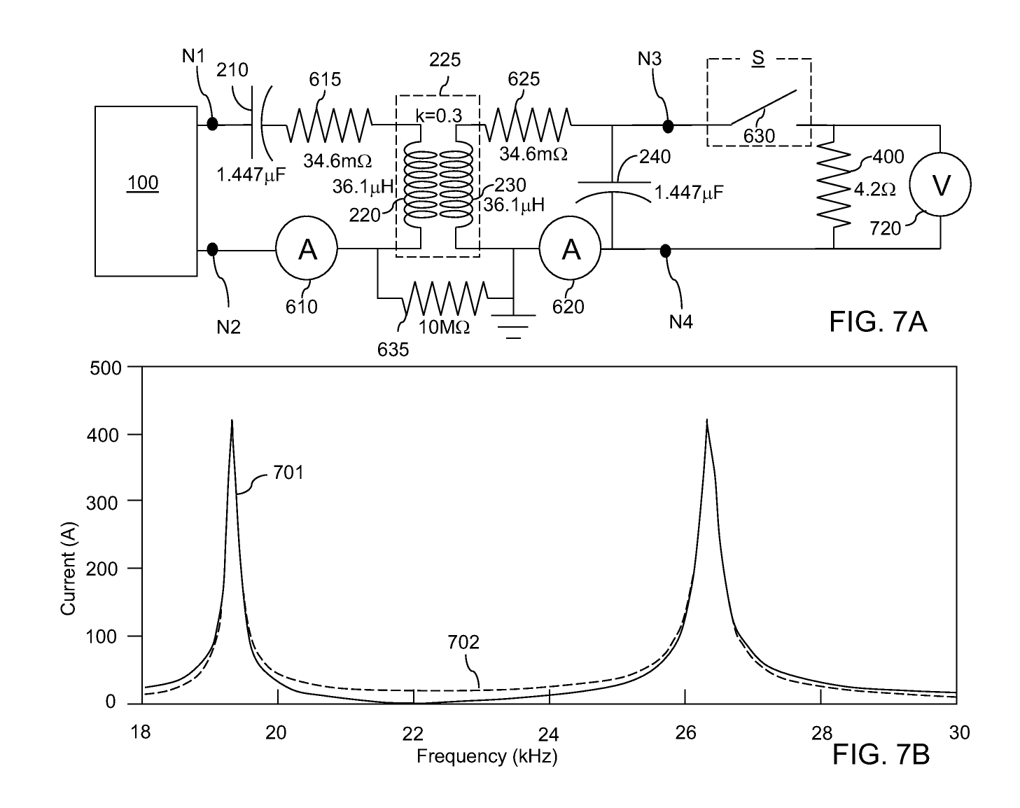

Referring to FIG. 7A, a schematic of a circuit of a second exemplary wireless power transfer apparatus is shown at a first circuit parameter setting. In the second exemplary wireless power transfer apparatus, the first exemplary power transfer apparatus was modified to substitute a switch S for a rectifier 300 (See FIG. 1) and to provide a parasitic resistor 635 between the primary circuit and the secondary circuit. In a practical setting, the resistance across the primary coil 220 and the secondary coil 230 is infinity. The presence of the parasitic resistor 635 in the simulations was a constraint imposed by the particular simulation program to eliminate floating grounds, i.e., to ensure that two electrical grounds converge to the same voltage. In reality, the parasitic resistor 635 is not needed because the primary coil 220 and the secondary coil 230 are separated by 150 to 200 mm through air. In that case 635 would be the resistance of air between the vehicle and earth, which is practically infinity. It could also represent a person in contact with the vehicle under charge to earth. Since both primary and secondary sides are isolated by the coupling coils 225, there would be zero current in element 635. The parasitic resistance of the primary coil 220 is simulated with a first resistor 615 having a first resistance of 34.6 mΩ The parasitic resistance of the secondary coil 230 is simulated with a second resistor 625 having a second resistance of 34.6 mΩ. The switch S is open so that the resistive load 400 does not affect the performance of the circuit of the second exemplary wireless power transfer apparatus. The values for self-inductances and capacitances are specified next to corresponding coils or corresponding capacitors. The resonance frequency f₀ in this case is 22.0 kHz.

A primary ammeter 610 is connected in a series connection with the primary coil 220 and the AC power supply source 100. The primary ammeter 610 measures the primary current A₁(t) that flows through the primary circuit, and specifically, through the primary coil 220 A secondary ammeter 620 is connected to one end of the secondary coil 230 and one end of the secondary capacitor 240. The secondary ammeter 620 measures the secondary current A₂(t) that flows through the secondary circuit, and specifically, through the secondary coil 230. A voltmeter 720 is connected across the resistive load 400. The voltmeter 720 measures the secondary voltage V₂(t) across the resistive load 400. The coupling constant k is 0.300 in the first circuit parameter setting. The switch S is open in the first circuit parameter setting.

Referring to FIG. 7B, a graph of simulated circuit characteristics for the circuit of FIG. 7A is shown. The graph of FIG. 7B illustrates the magnitude of the primary current A₁(t) as a function of the operating frequency of the AC power supply source 110 with a first curve 701, and the magnitude of the secondary current A₂(t) as a function of the operating frequency of the AC power supply source 110 with a second curve 702.

The input current through the primary circuit, i.e., the primary current A₁(t), at the resonance frequency f₀ is effectively zero. This is because the effective impedance of the secondary circuit as reflected back into the primary circuit through the inductive coupling structure 225 (i.e., the coupling coils) is a very high impedance. At off-resonance frequencies, this system of the second exemplary wireless power transfer apparatus exhibits bifurcated response in the magnitude of the primary current A₁(t), represented by the first curve 701, and in the magnitude of the secondary current A₂(t), represented by the second curve 702. The graph of FIG. 7B represents a frequency response function (FRF) of the network of the second exemplary wireless power transfer apparatus. The FRF of the network shows a peak near 19.3 kHz and 26.3 kHz, which are significantly removed from the resonance frequency f₀.

Neglecting the first resistance R₁ of the first resistor 615, the second resistance R₂ of the second resistor 625, and the resistance Rₚ of the parasitic resistor 635, the network input impedance Zᵢₙ, i.e., the impedance of the second exemplary wireless power transfer apparatus less the AC power supply source 100 as seen by the AC power supply source 100 across the first node N1 and the second node N2, is given by:

$${Z}_{i n} = j \{ ( ω {L}_{1} - \frac{1}{ω {C}_{1}} ) - \frac{{ω}^{2} {M}^{2}}{( ω {L}_{2} - \frac{1}{ω {C}_{2}} )} \} ,$$

in which M is the mutual inductance of the inductive coupling structure 225, ω is the angular frequency of the input signal, i.e., ω=2πf in which f is the operational frequency of the AC power supply source 100. The actual network input impedance Zᵢₙ is modified from the above formula through the first resistance R₁ of the first resistor 615, the second resistance R₂ of the second resistor 625, and the resistance Rₚ of the parasitic resistor 635.

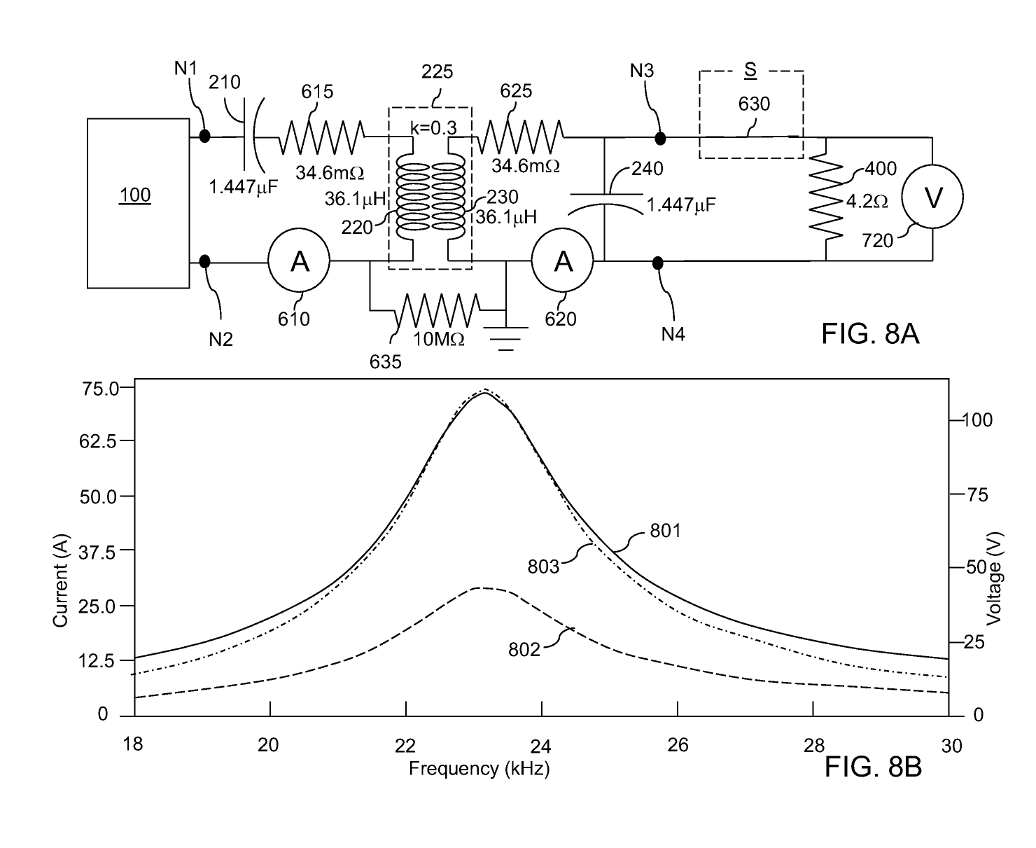

Referring to FIG. 8A, a schematic of a circuit of the second exemplary wireless power transfer apparatus is shown at a second circuit parameter setting. In the second circuit parameter setting, the switch S is closed to connect the resistive load 400 to the secondary circuit. The resistive load 400 has a resistance of 4.2Ω. Other parameters of the second circuit parameter setting as the same as the first circuit parameter setting. Thus, the resonance frequency f₀ is 22.0 kHz.

Referring to FIG. 8B, a graph of simulated circuit characteristics for the circuit of FIG. 8A is shown. The graph of FIG. 8B illustrates the magnitude of the primary current A₁(t) as a function of the operating frequency of the AC power supply source 110 with a first curve 801, the magnitude of the secondary current A₂(t) as a function of the operating frequency of the AC power supply source 110 with a second curve 802, and the magnitude of the secondary voltage V₂(t) as a function of the operating frequency of the AC power supply source 110 with a third curve 803.

The magnitude of the primary current A₁(t) has a peak of about 75 A at an operating frequency f of about 23.3 kHz, which is offset from the resonance frequency f₀ of 22.0 kHz by about 1.3 kHz. This is because the effective impedance of the secondary circuit as reflected back into the primary circuit through the inductive coupling structure 225 (i.e., the coupling coils) is a rather low impedance. The reflected load of the secondary circuit, i.e., the effective impedance of the secondary circuit, as seen in the primary circuit is determined by both the operating frequency f and mutual inductance M of the inductive coupling structure 225. The network input impedance Zᵢₙ does not have an absolute minimum magnitude at the resonance frequency f₀ of 22.0 kHz, but has a minimum magnitude at a frequency offset from the resonance frequency f₀ of 22.0 kHz. Thus, instead of the absolute minimum primary current A₁(t) at the resonance frequency f₀ illustrated in FIG. 7B, the network responds with a high input current peak at a frequency above the resonance frequency f₀ and a substantial, but less than maximum, current at the resonance frequency f₀. The offset between the operating frequency fat which the primary current A₁(t) has a peak and the resonance frequency f₀ is dependent on the coupling coefficient k and the resistance of the resistive load 400.

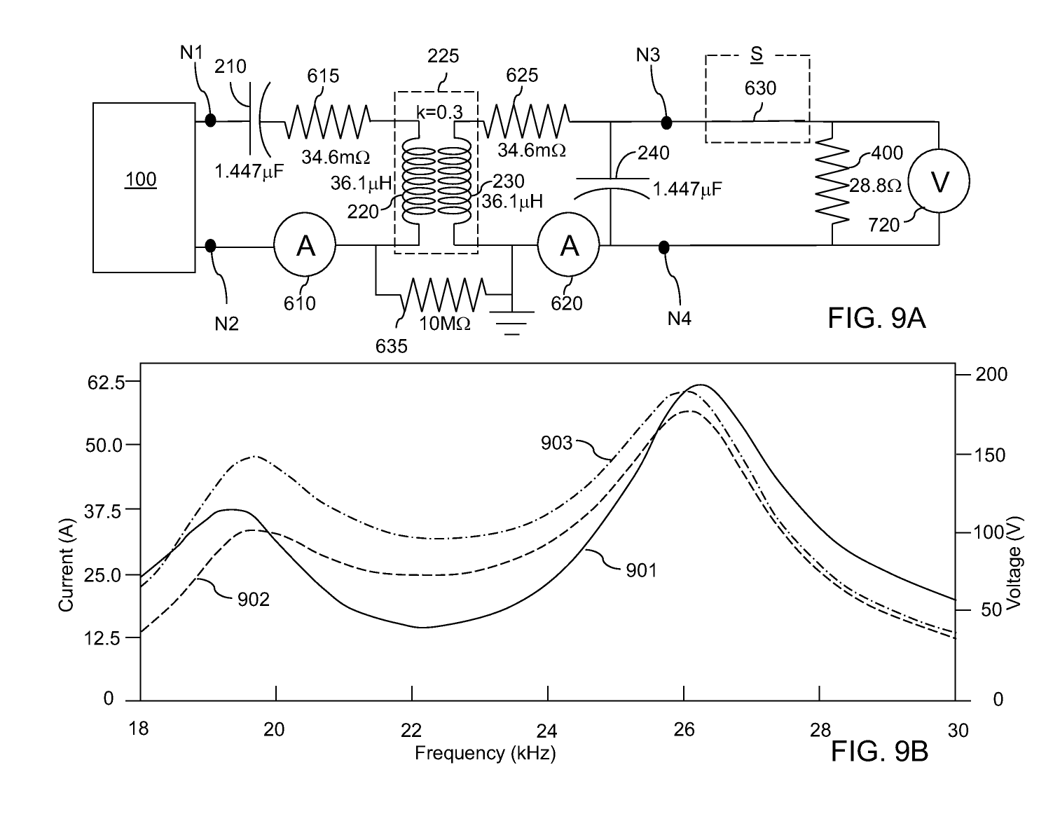

The load dependence of the offset between the operating frequency fat which the primary current A₁(t) has a peak and the resonance frequency f₀ is illustrated in FIGS. 9A and 9B. Referring to FIG. 9A, a schematic of a circuit of the second exemplary wireless power transfer apparatus is shown at a third circuit parameter setting. In the third circuit parameter setting, the switch S is closed to connect the resistive load 400 to the secondary circuit. The resistive load 400 has a resistance of 28.8Ω, which is about seven times as resistive as the resistance of 4.2Ω of the second circuit parameter setting of FIGS. 8A and 8B. Other parameters of the third circuit parameter setting as the same as the first and second circuit parameter settings. Thus, the resonance frequency f₀ is 22.0 kHz.

Referring to FIG. 9B, a graph of simulated circuit characteristics for the circuit of FIG. 9A is shown. The graph of FIG. 9B illustrates the magnitude of the primary current A₁(t) as a function of the operating frequency of the AC power supply source 110 with a first curve 901, the magnitude of the secondary current A₂(t) as a function of the operating frequency of the AC power supply source 110 with a second curve 902, and the magnitude of the secondary voltage V₂(t) as a function of the operating frequency of the AC power supply source 110 with a third curve 903.

Upon increase of the resistance of the resistive load 400 by about sevenfold relative to the second circuit parameter setting, the amount of power transfer in the third circuit parameter setting is significantly decreased relative to the amount of the power transfer that can be effected with the second circuit parameter setting. The frequency response function (FRF) of the network of the second exemplary wireless power transfer apparatus tends toward the FRF for the open circuit case illustrated in FIG. 7B. Thus, each of the first curve 901, the second curve 902, and the third curve 903 displays a peak above the resonance frequency f₀, and another peak below the resonance frequency f₀. The frequency of each peak does not necessarily coincide with frequencies of peaks in other curves among the first, second, and third curves (901, 902, 903). The absolute maximum for each of the first, second, and third curves (901, 902, 903) occurs at a frequency greater than the resonance frequency f₀. The shift of the peak that provides an absolute maximum for each of the first, second, and third curves (901, 902, 903) relative to the resonance frequency f₀ can be substantial. In this particular example, the ratio of the operating frequency at which any of the highest peaks in the first, second, and third curves (901, 902, 903) occurs to the resonance frequency f₀ is on the order of 26.5 kHz/22.0 kHz≅shift of the peak is on the order of 1.205. Comparison between FIGS. 8B and 9B shows that the offset between the operating frequency f at which the primary current A₁(t) has a peak and the resonance frequency f₀ is dependent on the magnitude of the resistive load 400 for a same coupling coefficient k.

A rectifier 300 can be introduced into the second exemplary wireless power transfer apparatus as in the case of the first exemplary wireless power transfer apparatus illustrated in FIG. 1. In this case, it can be shown that a diode rectified AC voltage (provided across the fifth node N5 and the sixth node N6 in FIG. 1) driving a fixed DC resistor load R_{Ldc} (such as the resistive load 400 in FIG. 1) in the first exemplary wireless power transfer apparatus can be represented on the AC side as a transformed resistance R_{Lac} (that substitutes the resistive load 400 in FIG. 8A or 9A) and a DC voltage U_{Ldc} transformed to an equivalent AC voltage U_{Lac} (that the same as the secondary voltage V₂(t)) in the circuit of the second exemplary wireless power transfer apparatus shown in FIG. 8B or 9B. In this case, the following relationship holds:

$${R}_{Lac} = \frac{{π}^{2}}{8} {R}_{Ldc} , \\ {U}_{Lac} = \frac{π}{2 \sqrt{2}} {U}_{Ldc} .$$

Therefore, an FRF for a circuit including a rectifier as in the first exemplary wireless power transfer apparatus illustrated in FIG. 1 exhibits qualitatively the same characteristics as an FRF for a circuit without a rectifier as in the second exemplary wireless power transfer apparatus.

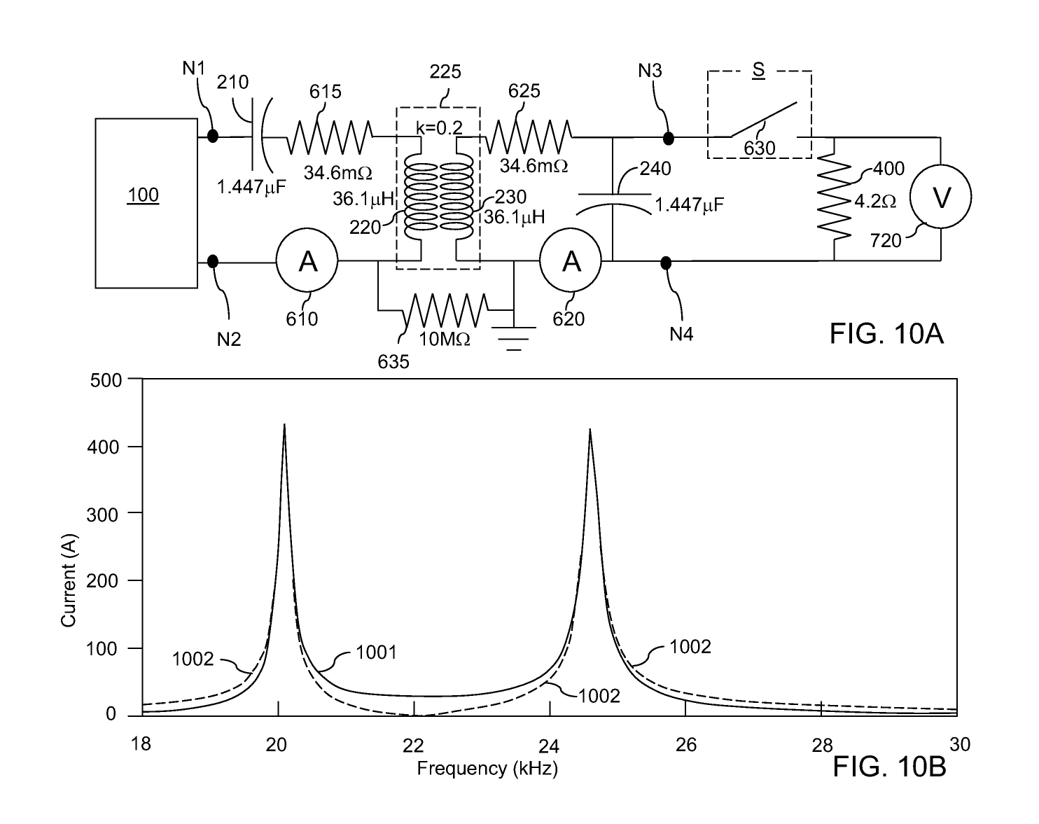

Referring to FIG. 10A, a schematic of a circuit of the second exemplary wireless power transfer apparatus is shown at a fourth circuit parameter setting. In the fourth circuit parameter setting is the same as the first circuit parameter setting except that the coupling constant k is set at 0.200. The reduction in the coupling constant k can be implemented, for example, by increasing the spacing s between the primary coil 220 and the secondary coil 230 in the exemplary inductive coupling structure 225 of FIGS. 3A-3C.

Referring to FIG. 10B, a graph of simulated circuit characteristics for the circuit of FIG. 10A is shown. The graph of FIG. 10B illustrates the magnitude of the primary current A₁(t) as a function of the operating frequency of the AC power supply source 110 with a first curve 1001, and the magnitude of the secondary current A₂(t) as a function of the operating frequency of the AC power supply source 110 with a second curve 1002.

A bifurcated FRF response is observed for the primary current A₁(t) and the secondary current A₂(t). The primary current A₁(t) has a resonant point of 22 kHz, which is the resonance frequency f₀. The FRF of the network shows a peak near 20.1 kHz and 24.8 kHz, which are removed from, but closer than corresponding peaks at the coupling coefficient of 0.300 (as illustrated in FIG. 7B) to, the resonance frequency f₀.

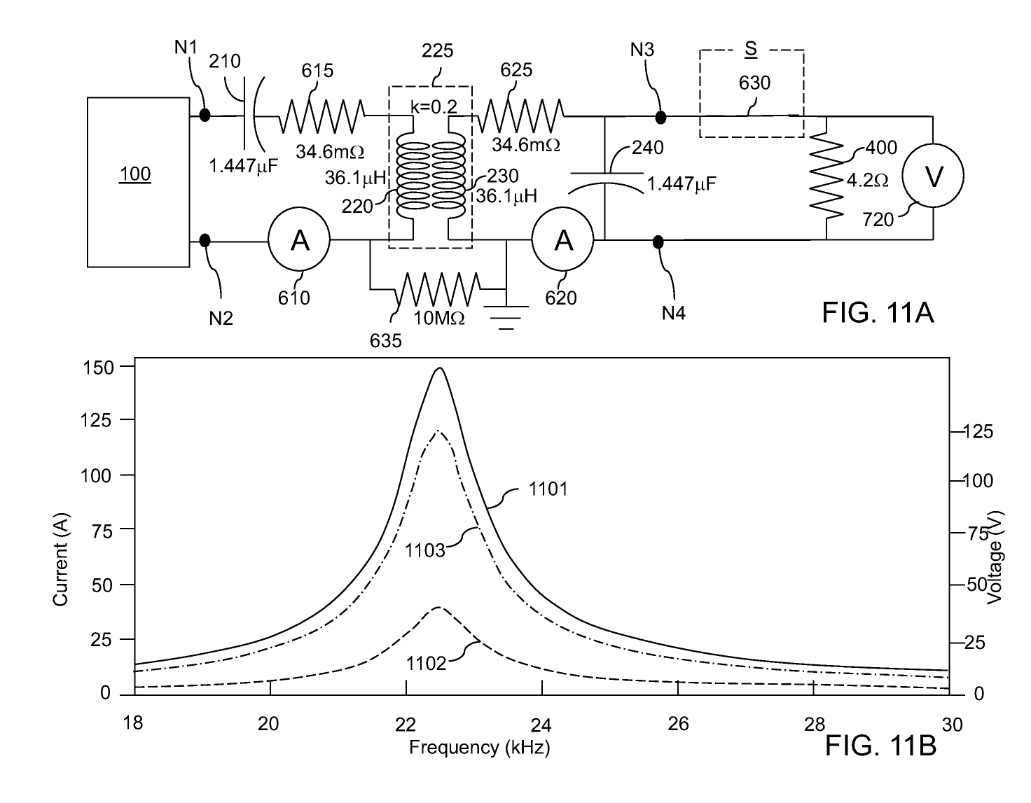

Referring to FIG. 11A, a schematic of a circuit of the second exemplary wireless power transfer apparatus is shown at a fifth circuit parameter setting. In the fifth circuit parameter setting, the switch S is closed to connect the resistive load 400 to the secondary circuit. The resistive load 400 has a resistance of 4.2Ω. Other parameters of the second circuit parameter setting as the same as the fourth circuit parameter setting. Particularly, the coupling constant k is 0.200. Thus, the resonance frequency f₀ is 22.0 kHz.

Referring to FIG. 11B, a graph of simulated circuit characteristics for the circuit of FIG. 11A is shown. The graph of FIG. 11B illustrates the magnitude of the primary current A₁(t) as a function of the operating frequency of the AC power supply source 110 with a first curve 1101, the magnitude of the secondary current A₂(t) as a function of the operating frequency of the AC power supply source 110 with a second curve 1102, and the magnitude of the secondary voltage V₂(t) as a function of the operating frequency of the AC power supply source 110 with a third curve 1103.

The magnitude of the primary current A₁(t) has a peak of about 150 A at an operating frequency f of about 22.6 kHz, which is offset from the resonance frequency f₀ of 22.0 kHz by about 0.6 kHz. The offset of 0.6 kHz in the frequency of the peak in the magnitude of the primary current A₁(t) from the resonance frequency f₀ in for the fifth circuit parameter setting is less than the corresponding offset of 1.3 kHz for the second circuit parameter setting because of the reduction in the coupling coefficient from 0.300 to 0.200 in the fifth circuit parameter setting. However, the height of the peak (of about 150 A) for the magnitude of the primary current A₁(t) at the fifth circuit parameter setting is greater than the height of the peak (of about 75 A) for the magnitude of the primary current A₁(t) at the second circuit parameter setting. As in FIG. 8B, the network input impedance Zᵢₙ does not have an absolute minimum magnitude at the resonance frequency f₀ of 22.0 kHz, but has a minimum magnitude at a frequency offset from the resonance frequency f₀ of 22.0 kHz. Comparison between FIGS. 8B and 11B shows that the offset between the operating frequency f at which the primary current A₁(t) has a peak and the resonance frequency f₀ is dependent on the coupling coefficient k for a same resistive load 400.

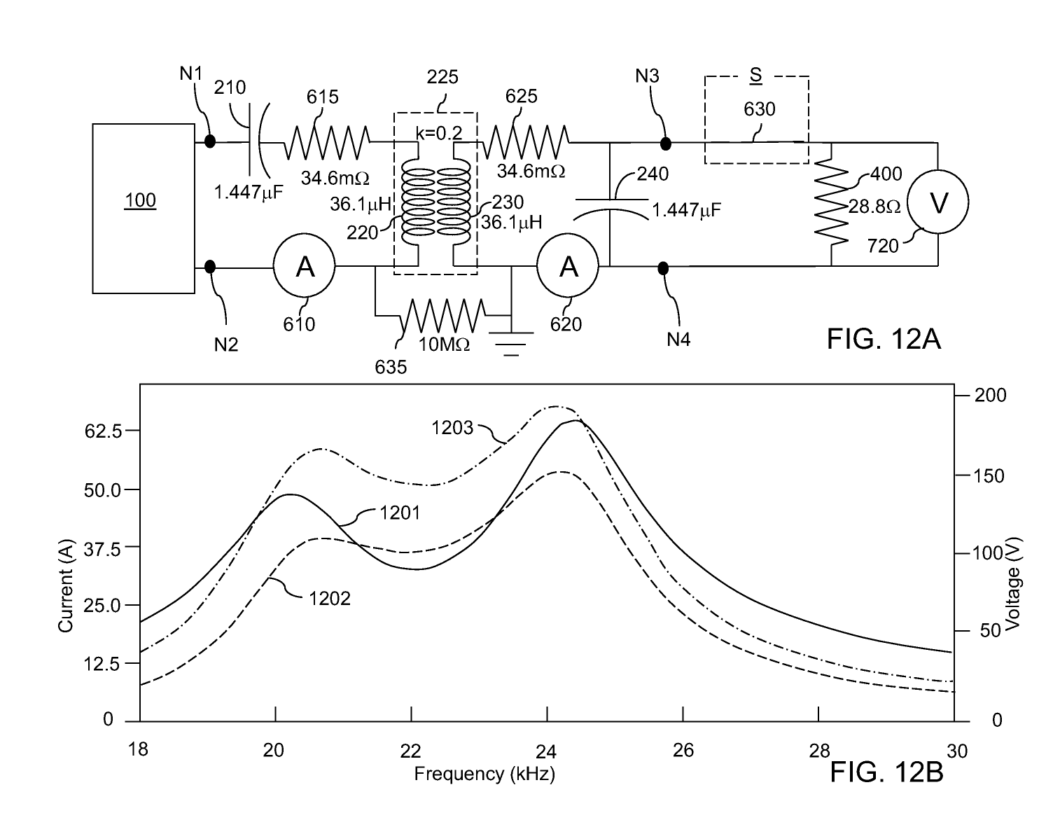

Referring to FIG. 12A, a schematic of a circuit of the second exemplary wireless power transfer apparatus is shown at a sixth circuit parameter setting. In the sixth circuit parameter setting, the switch S is closed to connect the resistive load 400 to the secondary circuit. The resistive load 400 has a resistance of 28.8Ω, which is about seven times as resistive as the resistance of 4.2Ω of the fifth circuit parameter setting of FIGS. 11A and 11B. Other parameters of the sixth circuit parameter setting as the same as the fourth and fifth circuit parameter settings. Thus, the resonance frequency f₀ is 22.0 kHz.

Referring to FIG. 12B, a graph of simulated circuit characteristics for the circuit of FIG. 12A is shown. The graph of FIG. 12B illustrates the magnitude of the primary current A₁(t) as a function of the operating frequency of the AC power supply source 110 with a first curve 1201, the magnitude of the secondary current A₂(t) as a function of the operating frequency of the AC power supply source 110 with a second curve 1202, and the magnitude of the secondary voltage V₂(t) as a function of the operating frequency of the AC power supply source 110 with a third curve 1203.

Each of the first curve 1201, the second curve 1202, and the third curve 1203 displays a peak above the resonance frequency f₀, and another peak below the resonance frequency f₀. The frequency of each peak does not necessarily coincide with frequencies of peaks in other curves among the first, second, and third curves (1201, 1202, 1203). The absolute maximum for each of the first, second, and third curves (1201, 1202, 1203) occurs at a frequency greater than the resonance frequency f₀. The shift of the peak that provides an absolute maximum for each of the first, second, and third curves (1201, 1202, 1203) relative to the resonance frequency f₀ can be substantial, but is less than the corresponding shift in FIG. 9B due to the reduction of the coupling constant k from 0.300 in the third circuit parameter setting to 0.200 in the sixth circuit parameter setting. In this particular example, the ratio of the operating frequency at which any of the highest peaks in the first, second, and third curves (1201, 1202, 1203) occurs to the resonance frequency f₀ is on the order of 24.4 kHz/22.0 kHz≅1.10. Comparison between FIGS. 11B and 12B shows that the offset between the operating frequency fat which the primary current A₁(t) has a peak and the resonance frequency f₀ is dependent on the magnitude of the resistive load 400 for a same coupling coefficient k. It is noted that that onset of the bifurcation as a function of the load impedance of the resistive load 400 occurs when the load impedance increases (total power transfer decreases), at which point the FRF transitions from a single peak dominance mode to a bifurcation mode. The minimum load impedance for the resistive load 400 at which the bifurcation of the peaks occur is herein referred to as a critical impedance.

For the configuration of the circuit of the second exemplary wireless power transfer apparatus as shown in FIGS. 8A, 9A, 11A, and 12A, if the resistance of the parasitic resistor 635, the parasitic resistance of the primary coil 220, and the parasitic resistance of the secondary coil 230 are not considered, the real part [symbol] (Zᵢₙ) of the network input impedance Zᵢₙ can be in given by:

$$( {Z}_{i n} ) = \frac{{ω}^{2} {M}^{2} ( \frac{{R}_{L}}{1 + {ω}^{2} {τ}^{2}} )}{{[ ( \frac{{R}_{L}}{1 + {ω}^{2} {τ}^{2}} ) + ( ω {L}_{2} - ( \frac{ω τ {R}_{L}}{1 + {ω}^{2} {τ}^{2}} ) ) ]}^{2}} ,$$

in which R_{L} is the resistance of the resistive load 400, and τ is the product of R_{L} and the secondary capacitance C₂, M is the mutual inductance of the inductive coupling structure 225 that is given by M=k\sqrt{L₁L₂}, L₂ is the secondary self-inductance of the secondary coil 230, and ω is the angular frequency of the AC signal provided by the AC power supply source 100, i.e., ω=2πf. Because M is linearly dependent on the coupling constant k, M is strongly influenced by the spacing between the primary coil 220 and the secondary coil 230.

In this case, the output power Pₒᵤₜ generated at the resistive load 400 is given by:

Pₒᵤₜ=0.5× [symbol] (Zᵢₙ)/|A₁|²,

in which A₁ is the absolute magnitude of the primary current A₁(t). A₁ is greater than the root mean square magnitude of the primary current A₁(t) by a factor of \sqrt{2}.

In one embodiment, the finite impedance load (300, 400) in FIG. 1 or the finite impedance load as represented by the resistive load 400 in FIGS. 10A and 12A can have a magnitude that provides two local peaks in the magnitude of the primary current A₁(t) as a function of frequency within a frequency range between 0 Hz and twice the resonance frequency f₀. By selecting the operating frequency f at which the Pₒᵤₜ is maximized for a given value for the finite impedance load (300, 400) in FIG. 1 or the resistive load 400 in FIGS. 10A and 12A, the power transfer rate can be effected at a greater rate than power transfer at the resonance frequency f₀. In a wireless power transfer system in which the value for the finite impedance load (300, 400) in FIG. 1 or the resistive load 400 in FIGS. 10A and 12A is fixed, the AC power supply source 100 can be configured to provide an input power to the primary coil and the primary capacitor at an operational frequency f that is greater than resonance frequency f₀. In one embodiment, the ratio of the operational frequency f to the resonance frequency f₀ as configured by such a system can be in a range from 1.0001 to 2.0000.

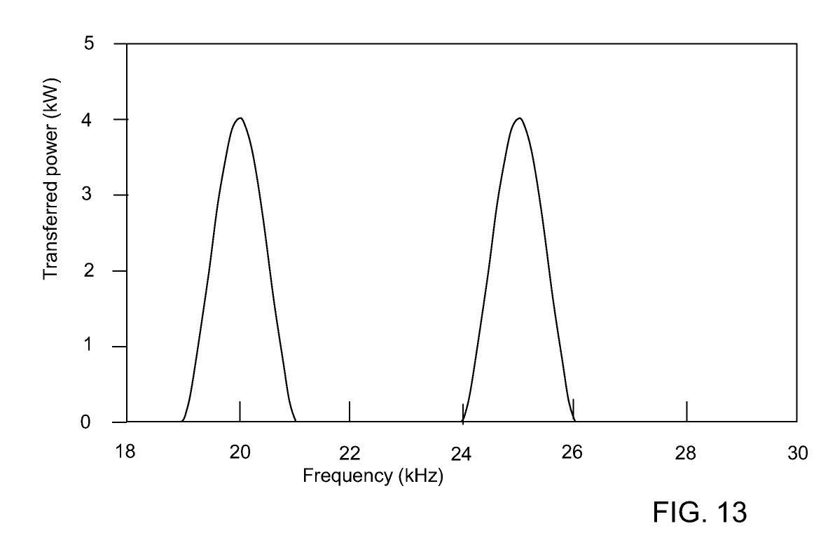

Referring to FIG. 13, a graph for a simulated wireless power transfer power output is shown for an ideal coil in a configuration of the second exemplary wireless power transfer apparatus having a same circuit parameter setting as the second circuit parameter setting of FIG. 8A with the modification of having a coupling constant k of 0.23, the resistance of the parasitic resistor 635 is set at infinity, and the parasitic resistance of the primary coil 220 and the parasitic resistance of the secondary coil 230 are set at zero. The load resistance is 4.2Ω in this simulation. The magnitude of the input voltage V₁(t) to the primary coil 220 is set at 30\sqrt{2} V. It is noted that the throughput power is sensitive to the coupling constant k, and therefore, is sensitive to the mutual inductance M and to the load resistance and to the relative magnitude of the load impedance relative to the primary side surge impedance and the critical impedance.

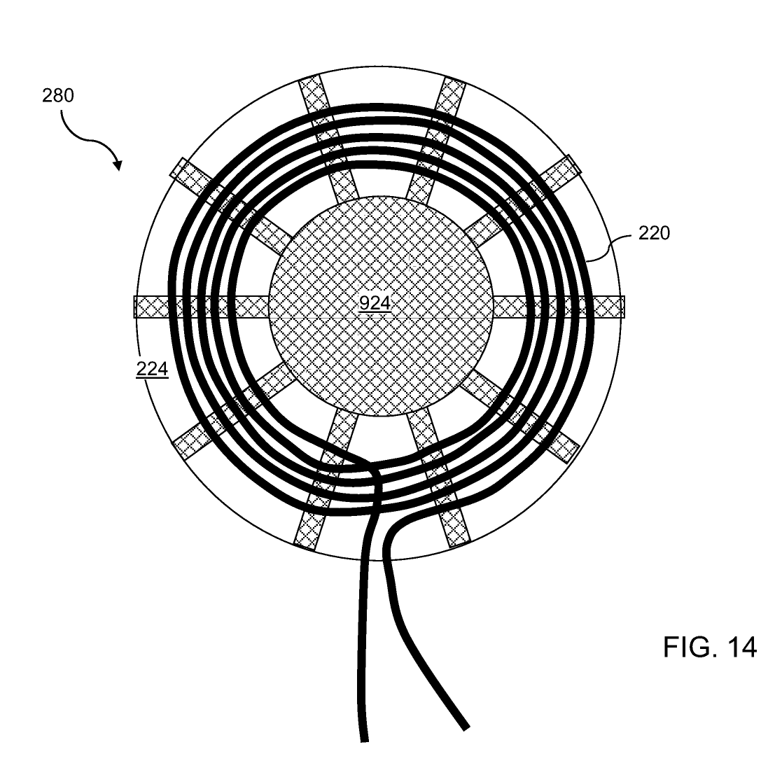

Referring to FIG. 14, an exemplary first structure that can be employed for an inductive coupling structure 225 is illustrated. The first structure 280 includes a primary coil 220 that is wound within a first two-dimensional plane. An end portion of the primary coil 220 that crosses over the wound portion of the primary coil 220 can be placed such that the end portion is farther away from a secondary coil (not shown; See FIG. 3A) than the wound portion of the primary coil 220. Further, the end portion of the primary coil 220 is routed to avoid electrically shorting with the wound portion of the primary coil 220. The first structure 280 can further include an insulating block structure 924 and a first ferromagnetic plate 224. The first block structure 924 includes a central insulating block of an insulating material (such as plastic or fiberglass) and radially extending structures configured to hold the primary coil. The first ferromagnetic plate 224 configured to capture and direct the magnetic flux generated from an alternating current that passes through the primary coil 220 in a direction perpendicular to the plane of the windings of the primary coil 220. The first ferromagnetic plate 224 can include a circular portion located within the primary coil 220, and radial portions that radially extend underneath the windings of the primary coil 220. The first ferromagnetic plate 224 can include ferrite sectors of suitable thickness such that magnetic saturation will not occur even at maximum input voltage. The first structure 280 further includes a first back side insulator layer (not shown; See FIG. 3A) that insulates the first ferromagnetic plate 224 from a first metallic plate 228. This configuration of the first structure 280 is herein referred to as a “pizza core coil configuration.”

An experimental hardware was constructed for a first structure 280 employing the pizza core coil configuration and a second structure 290 employing the same configuration. The mean diameter of the primary coil 220 was 330 mm, and the mean diameter of the secondary coil 230 was 330 mm in the first and second structures (280, 290), respectively. The first structure 280 and the second structure 290 were brought together to form an inductive coupling structure 225 such that the spacing between the primary coil 220 and the secondary coil 230 was set at 75 mm.

A high frequency power amplifier was used as the AC power supply source 110 to drive the primary coil 220 at a current of about 10 Aᵣₘₛ (root mean square amperage) in a frequency range around a resonance frequency of 19.5 Hz such that the unity power factor (zero reactive power) point can be tracked with variations in load power. In these tests, the rectified output voltage from the wireless power transfer apparatus was fixed at 36 V_{dc}, which corresponds to the DC voltage used for charging batteries for golf cart size vehicles. The operational frequency that provides the unity power factor was above the resonance frequency. Further, under such constraints, it was observed that increase in the load increase requires the operational frequency to be correspondingly increased. Specifically, to simultaneously maintain the root mean square magnitude of the primary current primary current A₁(t) at 10 mA and the power factor at unity while the magnitude of the resistive load 400 increased on the secondary circuit, the operating frequency f of the high frequency power amplifier needed to be changed from 19.8 kHz for the root mean square primary voltage of 5.78V (as applied across the primary coil 220), to 20.59 kHz for the root mean square primary voltage of 8.06 V, and then to 22.5 kHz for the root mean square primary voltage of 10.72V. Thus, the shift in the operational frequency that provides the most power transfer depends on the magnitude of the resistive load 400. Further, the observation of the same frequency shift for the operational frequency that provides the most power transfer relative to the resonance frequency in the experimental employing the pizza core coil configuration demonstrates that the shift in the operational frequency that provides the most power transfer relative to the resonance frequency occurs in many types of inductive coupling structures 225.

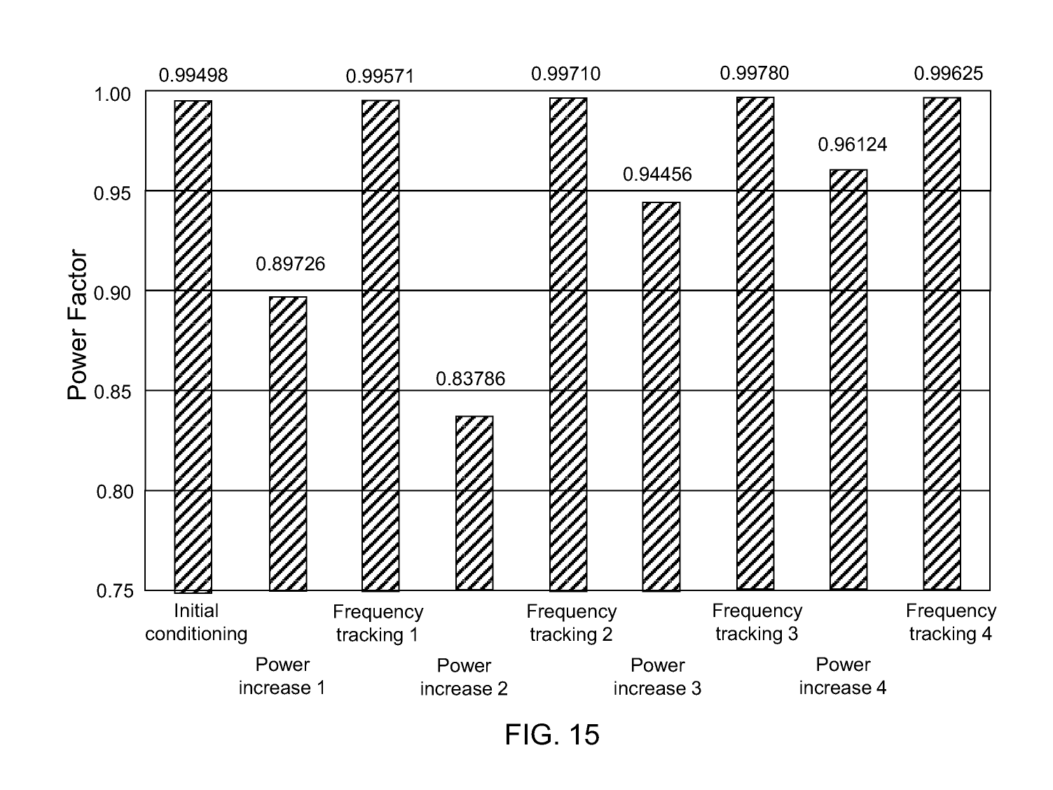

Referring to FIG. 15, the result of an experimental testing to quantify the frequency shifting is shown. The phase angle of the primary coil current relative to the primary coil fundamental voltage was observed at various steps of the testing, and the power factor, i.e., the cosine of the phase angle, at the various steps of the testing is shown in a bar chart. In the first step of initial conditioning, a finite load and the input frequency is adjusted to realize unity power factor (PF), at which the input current in phase with input voltage. Then the load was increased (by reducing the impedance of the resistive load 400) in the power increase 1 step, and a reduction in the power factor was observed. Frequency was then increased until unity PF was re-established in frequency tracking 1 step, and then the load was yet again increased in the power increase 2 step. Frequency tuning to achieve unity PF and increase in the load was repeated during the combinations of frequency tracking p step and power increase p+1 step for integer p from 2 to a 3. This test showed that delta-frequency adjustment is necessary above resonance to minimize reactive power and maximize efficiency.

While the invention has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Other suitable modifications and adaptations of a variety of conditions and parameters normally encountered in image processing, obvious to those skilled in the art, are within the scope of this invention. All publications, patents, and patent applications cited herein are incorporated by reference in their entirety for all purposes to the same extent as if each individual publication, patent, or patent application were specifically and individually indicated to be so incorporated by reference. Accordingly, the invention is intended to encompass all such alternatives, modifications and variations which fall within the scope and spirit of the invention and the following claims.

What is claimed is:

1. An apparatus for wireless power transmission, said apparatus comprising:
an inductive coupling structure comprising a primary coil and a secondary coil, wherein at least one of said primary coil and said secondary coil is movable, said primary coil being a component of a primary circuit comprising a primary capacitor in a connection with said primary coil, and said secondary coil being a component of a secondary circuit comprising a secondary capacitor in connection with said secondary coil;
an alternating current (AC) power supply source present within said primary circuit; and
a finite impedance load present within said secondary circuit and connected to said secondary coil and said secondary capacitor, wherein said AC power supply source is configured to provide an input power to said primary coil and said primary capacitor at an operational frequency f that is greater than a resonance frequency f₀ at which said coupling coils provide a maximum power transfer efficiency between said primary circuit and said secondary circuit for a hypothetical circuit in which said finite impedance load is substituted with an infinitesimally small resistive load.

2. The apparatus of claim 1, wherein said primary coil and said primary capacitor are in a series connection.

3. The apparatus of claim 2, wherein said secondary coil and said secondary capacitor are in a parallel connection.

4. The apparatus of claim 3, wherein an output node of said AC power supply source is connected directly to an end of said series connection and another output node of said AC power supply source is connected directly to another end of said series connection.

5. The apparatus of claim 4, wherein one end of said finite impedance load is connected directly to an end of said parallel connection, and another end of said finite impedance load is connected directly to another end of said parallel connection.

6. The apparatus of claim 3, wherein said primary coil has a first self-inductance L₁ and said primary capacitor has a first capacitance C₁, wherein values for said first self-inductance L₁ and said first capacitance C₁ satisfy a relationship given by
$${f}_{0} = \frac{1}{2 π \sqrt{{L}_{1} {C}_{1}}} .$$

7. The apparatus of claim 6, wherein said secondary coil has a second self-inductance L₂ and said secondary capacitor has a second capacitance C₂, wherein values for said second self-inductance L₂ and said second capacitance C₂ satisfy a relationship given by
$${f}_{0} = \frac{1}{2 π \sqrt{{L}_{2} {C}_{2}}} .$$

8. The apparatus of claim 1, wherein at least one of said primary coil and said secondary coil is configured to be movable without limitation on a maximum separation distance between said primary coil and said secondary coil.

9. The apparatus of claim 1, wherein an entirety of a space between said primary coil and said secondary coil is an air gap.

10. The apparatus of claim 1, wherein a ratio of said operational frequency f to said resonance frequency f₀ is in a range from 1.0001 to 2.0000.

11. The apparatus of claim 1, wherein said secondary circuit further comprises a rectifier, wherein said secondary coil and said secondary capacitor are connected to input nodes of said rectifier, and a resistive load is connected to output nodes of said rectifier.

12. The apparatus of claim 1, wherein said AC voltage supply source comprises an H-bridge circuit including four insulated gate bipolar transistors.

13. The apparatus of claim 1, wherein said resonance frequency f₀ is from 1 kHz to 1 MHz.

14. The apparatus of claim 1, wherein said finite impedance load has a magnitude that provides two local peaks in a magnitude of current in said primary circuit as a function of frequency within a frequency range between 0 Hz and twice said resonance frequency f₀.

15. The apparatus of claim 1, wherein said primary circuit and said secondary circuit are located in two separate structures, of which at least one is movable.

16. The apparatus of claim 15, wherein a first structure including said primary circuit is stationary, and a second structure including said secondary circuit is movable.

17. The apparatus of claim 15, wherein a first structure including said primary circuit is movable, and a second structure including said secondary circuit is movable.

18. The apparatus of claim 15, wherein said second structure is a vehicle configured to move on a road, in off-road terrain on land, on water, in water, or in air.

19. The apparatus of claim 1, wherein said AC power supply source is configured to generate an alternating voltage at said operational frequency f from a direct current power source.

20. The apparatus of claim 1, wherein said AC power supply source is configured to generate an alternating voltage at said operational frequency f from an alternating current power supply that operates at a frequency from 50 Hz to 60 Hz and at a voltage from 110 V to 220V.

21. A method of operating an apparatus for wireless power transmission, said method comprising:
providing an apparatus for wireless power transmission, said apparatus comprising:
an inductive coupling structure comprising a primary coil and a secondary coil, wherein at least one of said primary coil and said secondary coil is movable, said primary coil being a component of a primary circuit comprising a primary capacitor in a connection with said primary coil, and said secondary coil being a component of a secondary circuit comprising a secondary capacitor in connection with said secondary coil; and
an alternating current (AC) power supply source present within said primary circuit;
connecting a finite impedance load to said secondary circuit, wherein said finite impedance load is connected to said secondary coil and said secondary capacitor; and
providing an input power to said primary coil and said primary capacitor, employing said AC power supply source, at an operational frequency f that is greater than a resonance frequency f₀ at which said coupling coils provide a maximum power transfer efficiency between said primary circuit and said secondary circuit for a hypothetical circuit in which said finite impedance load is substituted with an infinitesimally small resistive load.

22. The method of claim 21, wherein said primary coil and said primary capacitor are in a series connection in said apparatus.

23. The method of claim 22, wherein said secondary coil and said secondary capacitor are in a parallel connection in said apparatus.

24. The method of claim 23, wherein an output node of said AC power supply source is connected directly to an end of said series connection and another output node of said AC power supply source is connected directly to another end of said series connection in said apparatus.

25. The method of claim 24, wherein said connecting of said finite impedance load to said secondary circuit further comprises:
connecting one end of said finite impedance load directly to an end of said parallel connection; and
connecting another end of said finite impedance load directly to another end of said parallel connection in said apparatus.

26. The method of claim 23, wherein said apparatus is provided such that said primary coil has a first self-inductance L₁ and said primary capacitor has a first capacitance C₁, wherein values for said first self-inductance L₁ and said first capacitance C₁ satisfy a relationship given by
$${f}_{0} = \frac{1}{2 π \sqrt{{L}_{1} {C}_{1}}} .$$

27. The method of claim 26, wherein said apparatus is provided such that said secondary coil has a second self-inductance L₂ and said secondary capacitor has a second capacitance C₂, wherein values for said second self-inductance L₂ and said second capacitance C₂ satisfy a relationship given by
$${f}_{0} = \frac{1}{2 π \sqrt{{L}_{2} {C}_{2}}} .$$

28. The method of claim 21, further comprising moving at least one of said primary coil and said secondary coil prior to said providing of said input power to said primary coil and said primary capacitor.

29. The method of claim 21, further comprising positioning said primary coil and said secondary coil such that an entirety of a space between said primary coil and said secondary coil is an air gap prior to said providing of said input power to said primary coil and said primary capacitor.

30. The method of claim 21, wherein said providing of said input power further comprises selecting said operational frequency f such that a ratio of said operational frequency f to said resonance frequency f₀ is in a range from 1.0001 to 2.0000.

31. The method of claim 21, wherein said secondary circuit further comprises a rectifier, wherein said secondary coil and said secondary capacitor are connected to input nodes of said rectifier, and a resistive load is connected to output nodes of said rectifier.

32. The method of claim 21, wherein said AC voltage supply source comprises an H-bridge circuit including four insulated gate bipolar transistors in said apparatus.

33. The method of claim 21, wherein said resonance frequency f₀ is from 1 kHz to 1 MHz in said apparatus.

34. The method of claim 21, wherein said finite impedance load has a magnitude that provides two local peaks in a magnitude of current in said primary circuit as a function of frequency within a frequency range between 0 Hz and twice said resonance frequency f₀.

35. The method of claim 21, wherein said primary circuit and said secondary circuit are provided as two separate structures, of which at least one is movable, and said method further comprises moving said at least one of said primary circuit and said secondary circuit prior to said providing of said input power to said primary coil and said primary capacitor.

36. The method of claim 35, wherein a first structure including said primary circuit is stationary, and a second structure including said secondary circuit is movable, and said method further comprises moving said secondary circuit prior to said providing of said input power to said primary coil and said primary capacitor.

37. The method of claim 35, wherein a first structure including said primary circuit is movable, and a second structure including said secondary circuit is movable, and said method further comprises moving said primary circuit prior to said providing of said input power to said primary coil and said primary capacitor.

38. The method of claim 35, wherein said second structure is a vehicle configured to move on a road, in off-road terrain on land, on water, in water, or in air.

39. The method of claim 21, further comprising generating an alternating voltage at said operational frequency f from a direct current power source within said AC power supply source.

40. The method of claim 21, further comprising generating an alternating voltage at said operational frequency f from an alternating current power supply that operates at a frequency from 50 Hz to 60 Hz and at a voltage from 110 V to 220V within said AC power supply source.
